(19) United States
(12) Patent Application Publication
(10) Pub. No.: US 2019/0129676 A1
(43) Pub. Date: May 2, 2019

(54) SYSTEMS, DEVICES, AND METHODS FOR WEARABLE COMPUTERS WITH HEADS-UP DISPLAYS

(71) Applicant: NORTH INC., Kitchener (CA)

(72) Inventors: Stephen Lake, Kitchener (CA); Stefan Alexander, Elmira (CA); Thomas Mahon, Guelph (CA)

(21) Appl. No.: 16/219,426

(22) Filed: Dec. 13, 2018

Related U.S. Application Data
(63) Continuation of application No. 14/704,663, filed on May 5, 2015, now abandoned.
(60) Provisional application No. 61/989,848, filed on May 7, 2014.

(51) Int. Cl. G06F 3/147; G02B 27/01; G06F 1/16; G06F 3/01; G09G 5/00

(52) U.S. Cl. CPC G06F 3/147; G02B 27/017; G06F 1/163; G06F 3/1454; G09G 5/003; G02B 2027/0178; G09G 2370/16; G06F 3/011

(57) ABSTRACT

Systems, devices, and methods for wearable computer systems are described. A wearable heads-up display (“WHUD”) is implemented as a peripheral to a wearable electronic band worn on a limb of the user. The majority (or all) of the application storage and processing is performed on the band instead of on the WHUD, and therefore the WHUD does not include all of the hardware infrastructure necessary for application storage and processing. This significantly reduces the bulk of the WHUD and enables more aesthetically pleasing WHUD designs. Graphics processing is also performed on the band instead of on the WHUD. In some implementations, rasterized display data is wirelessly transmitted from the band to the WHUD using an ultra-wideband wireless communication scheme. Gesture-based control of content displayed by the WHUD is enabled by sensors on-board the band itself or by a third wearable component in communication with the band.

### BACKGROUND

### Technical Field

The present systems, devices, and methods generally relate to wearable computers with wearable heads-up displays and particularly relate to wearable computer systems in which a wearable heads-up display serves as a display peripheral that wirelessly receives processed display data from a separate wearable electronic band.

### Description of the Related Art

### Wearable Electronic Devices

Electronic devices are commonplace throughout most of the world today. Advancements in integrated circuit technology have enabled the development of electronic devices that are sufficiently small and lightweight to be carried by the user. Such “portable” electronic devices may include on-board power supplies (such as batteries or other power storage systems) and may be designed to operate without any wire-connections to other, non-portable electronic systems; however, a small and lightweight electronic device may still be considered portable even if it includes a wire-connection to a non-portable electronic system. For example, a microphone may be considered a portable electronic device whether it is operated wirelessly or through a wire-connection.

The convenience afforded by the portability of electronic devices has fostered a huge industry. Smartphones, audio players, laptop computers, tablet computers, and ebook readers are all examples of portable electronic devices. However, the convenience of being able to carry a portable electronic device has also introduced the inconvenience of having one's hand(s) encumbered by the device itself. This problem is addressed by making an electronic device not only portable, but wearable.

A wearable electronic device is any portable electronic device that a user can carry without physically grasping, clutching, or otherwise holding onto the device with their hands. For example, a wearable electronic device may be attached or coupled to the user by a strap or straps, a band or bands, a clip or clips, an adhesive, a pin and clasp, an article of clothing, tension or elastic support, an interference fit, an ergonomic form, etc. Examples of wearable electronic devices include digital wristwatches, electronic bands, electronic rings, electronic ankle-bracelets or “anklets,” heads-up display units, hearing aids, and so on.

### Wearable Heads-Up Displays

While wearable electronic devices may be carried and, at least to some extent, operated by a user without encumbering the user's hands, many wearable electronic devices include at least one electronic display. Typically, in order for the user to access (i.e., see) and interact with content presented on such electronic displays, the user must modify their posture to position the electronic display in their field of view (e.g., in the case of a wristwatch, the user may twist their arm and raise their wrist towards their head) and direct their attention away from their external environment towards the electronic display (e.g., look down at the wrist bearing the wristwatch). Thus, even though the wearable nature of a wearable electronic device allows the user to carry and, to at least some extent, operate the device without occupying their hands, accessing and/or interacting with content presented on an electronic display of a wearable electronic device may occupy the user's visual attention and limit their ability to perform other tasks at the same time.

The limitation of wearable electronic devices having electronic displays described above may be overcome by wearable heads-up displays. A wearable heads-up display is a head-mounted display that enables the user to see displayed content but does not prevent the user from being able to see their external environment. A typical head-mounted display (e.g., well-suited for virtual reality applications) may be opaque and prevent the user from seeing their external environment, whereas a wearable heads-up display (e.g., well-suited for augmented reality applications) may enable a user to see both real and virtual/projected content at the same time. A wearable heads-up display is an electronic device that is worn on a user's head and, when so worn, secures at least one electronic display within the field of view of at least one of the user's eyes at all times, regardless of the position or orientation of the user's head, but this at least one display is either transparent or at a periphery of the user's field of view so that the user is still able to see their external environment. Examples of wearable heads-up displays include: the Google Glass®, the Optinvent Ora®, the Epson Moverio®, the Sony Glasstron®, just to name a few. For the purposes of the present systems, devices, and methods, a ‘wearable heads-up display” may synonymously be referred to as a “transparent head-mounted display” or a “transparent head-worn display.”

A challenge in the design of wearable heads-up displays is minimizing the bulk of the hardware. Wearable heads-up displays are worn on a user's head/face and, as a result, are not easily concealed. They are inevitably conveyed and perceived as part of a user's overall physical appearance. All of the wearable heads-up displays available today are noticeably bulkier than a typical pair of corrective eyeglasses or sunglasses and their aesthetic appeal is compromised by this bulk. The bulk is due to at least two factors: i) the display technology employed includes inherently bulky waveguides, lenses, prisms, and/or projection schemes, and/or ii) the wearable heads-up display is a self-sufficient computing unit (e.g., a pair of “smartglasses”) that includes many components dedicated to performing non-display functions, such as wireless internet connectivity, application processing and storage, and input processing for controlling displayed content. In other words, the wearable heads-up displays that are available today are typically designed and built as stand-alone computers and so carry all of the bulk associated with computer hardware. There is a need in the art for wearable heads-up displays of reduced bulk that allow for a more aesthetically-appealing design while still providing highly developed content to the user.

### BRIEF SUMMARY

A wearable computer system may be summarized as including a peripheral wearable heads-up display (“WHUD”) that, in use, is worn on a head of a user, wherein the peripheral WHUD includes at least a first display element positioned within a field of view of at least a first eye of the user when the peripheral WHUD is worn on the head of the user and a wireless receiver communicatively coupled to the at least a first display element; and a wearable electronic band that, in use, is worn on a limb of the user, wherein the wearable electronic band includes a processor, a non-transitory processor-readable storage medium communicatively coupled to the processor, and a wireless transmitter communicatively coupled to the processor, and wherein the non-transitory processor-readable storage medium stores processor-executable display instructions that, when executed by the processor, cause the wearable electronic band to define and wirelessly transmit display data to the peripheral WHUD and wherein, in response to wirelessly receiving the display data from the wearable electronic band, the peripheral WHUD operates the at least a first display element to display information to the user. The peripheral WHUD may include a first discrete power source. The wearable electronic band may include a second discrete power source. The first discrete power source of the peripheral WHUD may include a first battery and the second discrete power source of the wearable electronic band may include a second battery.

The wearable electronic band may further include a wireless transceiver communicatively coupled to the processor, wherein in use the wireless transceiver provides wireless Internet connectivity for the wearable computer system. The non-transitory processor-readable storage medium of the wearable electronic band may further store processor-executable application instructions that, when accessed by the processor, cause the wearable electronic band to execute at least one application that invokes the display instructions to define and wirelessly transmit display data to the peripheral heads-up display.

The wearable electronic band may include at least one sensor communicatively coupled to the processor, wherein in use the at least one sensor detects at least one input and, in response to the at least one detected input, the wearable computer system modifies at least some data displayed to the user by the peripheral heads-up display. The at least one sensor may include at least one muscle activity sensor responsive to muscle activity of the user when the user performs a physical gesture. The at least one sensor may be selected from the group consisting of: an electromyography sensor, a mechanomyography sensor, an accelerometer, a gyroscope, an electrocardiography sensor, a blood pressure sensor, a global positioning system sensor, and a compass.

The at least a first display element of the peripheral WHUD may include both a first display element and a second display element, and when the peripheral WHUD is worn on the head of the user the first display element may be positioned in the field of view of the first eye of the user and the second display element may be positioned in a field of view of a second eye of the user. The peripheral WHUD may have a shape and appearance of a set of eyeglasses. The peripheral WHUD and the wearable electronic band may be discrete, physically separate components of the wearable computer system.

The display instructions stored in the non-transitory processor-readable storage medium of the wearable electronic band may include rasterization instructions that, when executed by the processor, cause the wearable electronic band to define and wirelessly transmit rasterized display data to the peripheral heads-up display. In response to wirelessly receiving the rasterized display data from the wearable electronic band, the peripheral WHUD may operate the at least a first display element to display the rasterized display data to the user.

The wireless receiver of the peripheral WHUD may include an ultra-wideband wireless receiver and the wireless transmitter of the wearable electronic band may include an ultra-wideband wireless transmitter.

A method of operating a wearable computer system, wherein the wearable computer system comprises a wearable electronic band worn on a limb of a user and a peripheral WHUD worn on a head of the user, may be summarized as including: defining display data by a processor on-board the wearable electronic band; wirelessly transmitting the display data by a wireless transmitter on-board the wearable electronic band; wirelessly receiving the display data by a wireless receiver on-board the peripheral heads-up display; and displaying information to the user based on the display data by at least a first display element of the peripheral heads-up display. Defining display data by a processor on-board the wearable electronic band may include rasterizing the display data by the processor on-board the wearable electronic band; wirelessly transmitting the display data by a wireless transmitter on-board the wearable electronic band may include wirelessly transmitting the rasterized display data by the wireless transmitter on-board the wearable electronic band; and wirelessly receiving the display data by a wireless receiver on-board the peripheral WHUD may include wirelessly receiving the rasterized display data by the wireless receiver on-board the peripheral heads-up display. Displaying information to the user based on the display data by at least a first display element of the peripheral WHUD may include displaying the rasterized display data to the user by the at least a first display element of the peripheral heads-up display.

Displaying information to the user based on the display data by at least a first display element of the peripheral WHUD may include displaying information to a first eye of the user based on the display data by a first display element of the peripheral WHUD and displaying information to a second eye of the user based on the display data by a second display element of the peripheral heads-up display. Wirelessly transmitting the display data by a wireless transmitter on-board the wearable electronic band may include wirelessly transmitting the display data over an ultra-wideband frequency range by an ultra-wideband wireless transmitter on-board the wearable electronic band, and wirelessly receiving the display data by a wireless receiver on-board the peripheral WHUD may include wirelessly receiving the display data over the ultra-wideband frequency range by an ultra-wideband wireless receiver on-board the peripheral heads-up display.

Defining display data by a processor on-board the wearable electronic band may include executing, by the processor on-board the wearable electronic band, processor-executable display instructions stored in a non-transitory processor-readable storage medium on-board the wearable electronic band that cause the processor on-board the wearable electronic band to define the display data. The method may further include executing, by the processor on-board the wearable electronic band, an application stored in a non-transitory processor-readable storage medium on-board the wearable electronic band, wherein the application includes display instructions, and wherein defining display data by a processor on-board the wearable electronic band includes executing the display instructions of the application by the processor.

The method may further include: wirelessly transmitting information to the internet by a wireless transceiver on-board the wearable electronic band; and wirelessly receiving information from the internet by the wireless transceiver on-board the wearable electronic band, wherein defining display data by a processor on-board the wearable electronic band includes defining display data by the processor on-board the wearable electronic band based on the information wirelessly received from the internet.

The method may further include: detecting, by at least one sensor on-board the wearable electronic band, at least one input from the user, wherein defining display data by a processor on-board the wearable electronic band includes defining display data by the processor on-board the wearable electronic band based on the at least one input from the user. Detecting, by at least one sensor on-board the wearable electronic band, at least one input from the user may include detecting, by at least one electromyography sensor on-board the wearable electronic band, at least one physical gesture performed by the user.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn necessarily to scale, and some of these elements are arbitrarily enlarged and positioned to improve drawing legibility. Further, the particular shapes of the elements as drawn are not necessarily intended to convey any information regarding the actual shape of the particular elements, and have been solely selected for ease of recognition in the drawings.

FIG. 1A is an illustrative diagram of a wearable computer system that includes a wearable electronic band wirelessly communicatively coupled to a peripheral wearable heads-up display in accordance with the present systems, devices, and methods.

FIG. 1B is an alternate illustrative view of the wearable computer system from FIG. 1A.

FIG. 2A is a flow-diagram showing a method of operating a wearable computer system in accordance with the present systems, devices, and methods.

FIG. 2B is a flow-diagram showing another method of operating a wearable computer system in accordance with the present systems, devices, and methods.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with electronic devices, and in particular portable electronic devices such as wearable electronic devices, have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

The headings and Abstract of the Disclosure provided herein are for convenience only and do not interpret the scope or meaning of the embodiments.

The various embodiments described herein provide systems, devices, and methods for multi-part wearable computers that include a wearable heads-up display as a peripheral display device communicatively coupled to a separate wearable electronic device that performs the majority of the computing functions. As a peripheral device, the wearable heads-up display is significantly simplified compared to stand-alone wearable heads-up displays because hardware and software components that provide, e.g., application processing, internet connectivity, and even graphics rendering/display data definition may all be contained in/on the separate wearable electronic device as opposed to in/on the wearable heads-up display itself. This allows for wearable heads-up display designs that are less bulky and more aesthetically appealing than other wearable heads-up displays available today. In accordance with the present systems, devices, and methods, peripheral wearable heads-up displays can also enjoy longer battery life compared to stand-alone wearable heads-up display devices.

Throughout this specification and the appended claims, the term “peripheral” is used to refer to a physical component of a computer system that interacts with the main computational element (e.g., the processor, or CPU) but does not itself include or provide part of the core computer architecture. A peripheral provides a specific function or capability by sending data to and/or receiving data from the processor but does not itself perform any of the core computational processing tasks. Common examples of peripheral devices include computer mice, keyboards, monitors, printers, and speakers. In some cases, a peripheral device may include a specialized processor to assist in performing the limited tasks associated with the peripheral device, but a specialized processor in a peripheral device does not perform the main computational functions of the system.

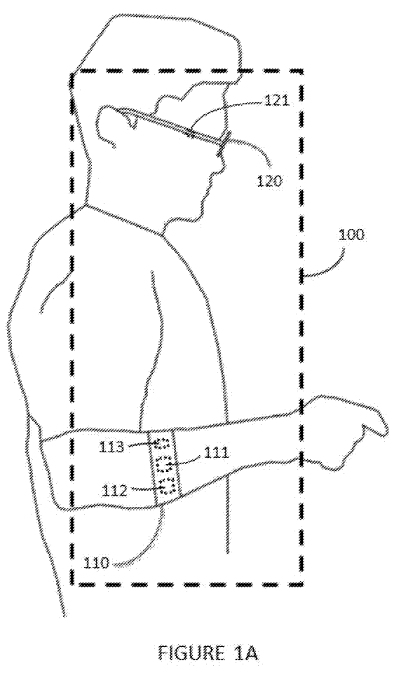

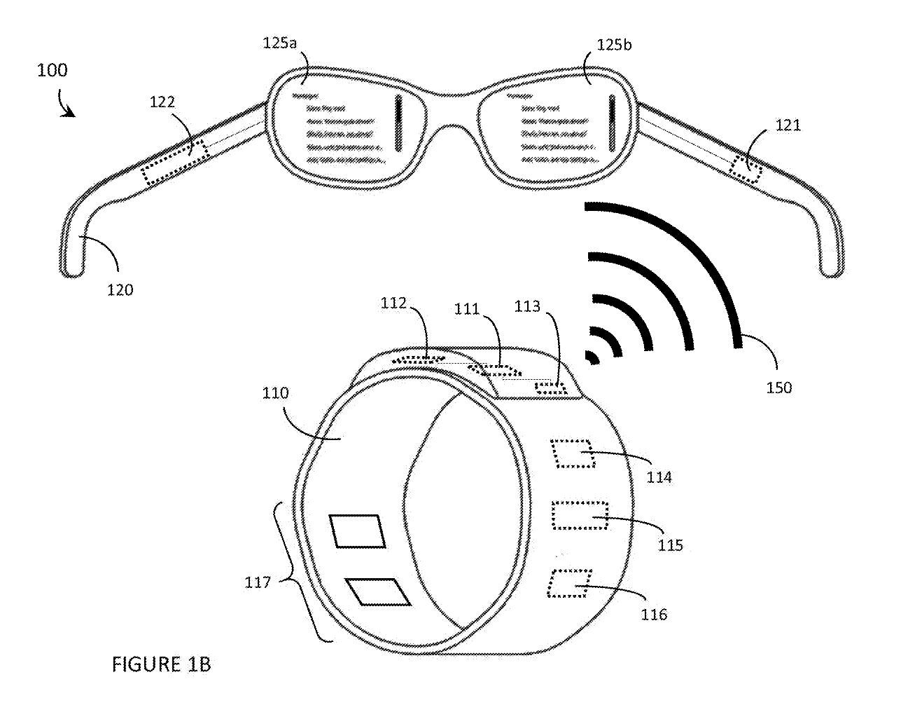

FIG. 1A is an illustrative diagram of a wearable computer system 100 that includes a wearable electronic band 110 wirelessly communicatively coupled to a peripheral wearable heads-up display (“WHUD”) 120 in accordance with the present systems, devices, and methods. In use, band 110 is worn on a limb of the user. In the illustrated example, band 110 is an armband that is worn on an arm of the user, but in alternative implementations band 110 may be worn elsewhere on the body of the user, such as on the user's wrist, finger, or leg, or alternatively band 110 may include or be coupled to a belt worn around the user's waist. In use, peripheral WHUD 120 is worn on the head of the user. Band 110 and peripheral WHUD 120 are, in the illustrated example of FIG. 1A, discrete, physically separate components of wearable computer system 100, though in alternative implementations at least one physical connection (such as a structural coupling and/or a physical wire connection) may exist between band 110 and peripheral WHUD 120.

Band 110 carries the main computational elements of wearable computer system 100. Specifically, band 100 carries at least a computer processor 111, a non-transitory processor-readable storage medium or memory 112 that is communicatively coupled to processor 111, and a wireless transmitter 113 that is communicatively coupled to processor 111. Processor 111 may be any type of processor, including but not limited to: a digital microprocessor or microcontroller, an application-specific integrated circuit (ASIC), a field-programmable gate array (FPGA), a digital signal processor (DSP), a graphics processing unit (GPU), a programmable gate array (PGA), a programmable logic unit (PLU), or the like. Memory 112 stores at least processor-executable display instructions that, when executed by processor 111, cause band 110 to define display data (i.e., by processor 111) and wirelessly transmit the display data (i.e., by transmitter 113).

Peripheral WHUD 120 is communicatively coupled to band 110 and, in use, displays content to the user in a manner similar to a typical computer monitor. Peripheral WHUD 120 includes a wireless receiver 121 to receive the display data wirelessly transmitted from band 110 (i.e., by transmitter 113) and at least a first display element (not called out in FIG. 1A) communicatively coupled to receiver 121. In response to wirelessly receiving the display data from band 110, peripheral WHUD 120 operates the at least a first display element to display information to the user. Further details of wearable computer system 100 are apparent in the alternate view of FIG. 1B in which the components of wearable computer system 100 are depicted off of the body of the user.

FIG. 1B is an alternate illustrative view of wearable computer system 100 from FIG. 1A. The view of FIG. 1A illustrates an example of how the elements of wearable computer system 100 may be worn on the body of a user while in use. In the alternate view of FIG. 1B, the components of wearable computer system 100 are depicted off of the body of the user and re-oriented to reveal additional features.

FIG. 1B shows that band 110 includes further elements in addition to processor 111, memory 112, and transmitter 113. For example, FIG. 1B shows that band 110 includes: a wireless transceiver 114 to provide wireless Internet connectivity for wearable computer system 100; a first sensor 115 that is responsive to (i.e., detects, senses, measures, or transduces) at least one input from the user and/or from the user's environment; a first discrete power source 116 (e.g., a first battery); and at least a second sensor 117 that is responsive to (i.e., detects, senses, measures, or transduces) at least one input from the user. Either or both of first sensor 115 and second sensor 117 may include any or all of, for example: an accelerometer, a gyroscope, a global positioning system (“GPS”) sensor, a compass, an electromyography (“EMG”) sensor, a mechanomyography (“MMG”) sensor, an electrocardiography (“ECG”) sensor, and/or a blood pressure sensor. Any and/or all of sensors 115 and 117 may be used to modify, control, or interact with information that is displayed to the user by peripheral WHUD 120 in response to detected inputs from the user and/or from the user's environment. In the illustrated example of FIG. 1B, each of first sensor 115 and second sensor 117 includes a respective EMG sensor responsive to muscle activity of the user when the user performs one or more physical gesture(s).

FIG. 1B also shows that peripheral WHUD 120 includes further elements in addition to wireless receiver 121. For example, FIG. 1B shows that peripheral HUD 120 includes: a first display element 125a that is positioned within a field of view of a first eye of a user when peripheral WHUD 120 is worn on the user's head; a second display element 125b that is positioned within a field of view of a second eye of the user when peripheral WHUD 120 is worn on the user's head; and a second discrete power source 122 (e.g., a second battery). In accordance with the present systems, devices, and methods, peripheral WHUD 120 has a general shape and appearance of a set of eyeglasses, which is facilitated by the fact that peripheral WHUD 120 does not include many computational elements (e.g., processor 111 and memory 112) that are typically included in/on other heads-up displays available today. In wearable computer system 100, the majority (and in some implementations, all) of the computational processing tasks are completed on-board band 110 as opposed to on-board peripheral WHUD 120 and, as a result of such computational processing, display data is wirelessly transmitted from band 110 to peripheral WHUD 120 to be displayed to the user.

Wearable computer system 100 may include a gesture-based control device in order to interact with content displayed on peripheral WHUD 120, as described in U.S. Non-Provisional patent application Ser. No. 14/155,087 ('087) and U.S. Non-Provisional patent application Ser. No. 14/155,107 ('107), both of which are incorporated by reference herein in their entirety. In the '087 and '107 patent applications, gesture-based control signals are wirelessly transmitted to a wearable heads-up display and processed by a processor on-board the wearable heads-up display in order to define display data, whereas in the present systems, devices, and methods, gesture-based control signals are processed by at least one processor on-board a wearable electronic band (e.g., band 110), and the same at least one processor on-board the same wearable electronic band defines display data based on processing the gesture-based control signals. The display data is then wirelessly transmitted from the band to a peripheral WHUD (e.g., 120) to be displayed thereby with minimal (in some cases with no) further processing by the peripheral WHUD. Band 110 may itself include features and components in order to provide the functions of a gesture-based control device, as described in, for example, U.S. Non-Provisional patent application Ser. No. 14/186,878; U.S. Non-Provisional patent application Ser. No. 14/186,889; U.S. Provisional Patent Application Ser. No. 61/822,740; U.S. Provisional Patent Application Ser. No. 61/869,526 (now U.S. Non-Provisional patent application Ser. No. 14/465,194); and/or U.S. Provisional Patent Application Ser. No. 61/874,846 (now U.S. Non-Provisional patent application Ser. No. 14/476,093), each of which is incorporated by reference herein in its entirety. Alternatively, wearable computer system 100 may include a third wearable component (i.e., another band in addition to band 110, or a component worn elsewhere on the user's body) that provides the functions of a gesture-based control device. In this case, the third component (i.e., the dedicated gesture-based control device) may transmit gesture-based control signals to band 110, which may process the gesture-based control signals and, in response to the gesture-based control signals, define display data that is then transmitted from band 110 to peripheral WHUD 120.

Peripheral WHUD 120 (and more specifically, display elements 125a and 125b thereof) may implement any of a wide range of display technologies. However, as previously described, for aesthetic purposes it may be advantageous to employ a display technology that is relatively compact and/or has little to no physical footprint on the frame of the headset/eyeglasses. An example of a display technology that satisfies these criteria and is particularly well-suited for use in the peripheral WHUDs of the present systems, devices, and methods is described in U.S. Provisional Patent Application Ser. No. 61/928,568 (now U.S. Non-Provisional patent application Ser. No. 14/599,279), which is incorporated by reference herein in its entirety.

Both band 110 and peripheral WHUD 120 may each include some components that are carried on or at external surfaces thereof. Such “external” components may be visible in the views of FIGS. 1A and 1B. However, both band 110 and peripheral WHUD 120 may also each include one or more respective housing(s) with some components contained within the housing(s). Such “internal” components may not be visible in the views of FIGS. 1A and 1B (unless the housings are made of optically transparent or translucent material). Internal components of band 110 (e.g., processor 111) and peripheral WHUD 120 (e.g., battery 122) that, in the illustrated example, may not normally be visible in the views of FIGS. 1A and 1B are depicted by dashed lines in FIGS. 1A and 1B.

As previously described, band 110 and peripheral WHUD 120 are wirelessly communicatively coupled. In particular, processor 111 on-board band 110 defines display data and transmitter 113 on-board band 110 wirelessly transmits this display data. The display data is wirelessly received by receiver 121 on-board peripheral WHUD 120 and displayed to the user by first and second display elements 125a and 125b. FIG. 1B shows wireless display data signals 150 transmitted from transmitter 113 of band 110 to receiver 121 of peripheral WHUD 120. In principle, wireless display data signals 150 may be transmitted between band 110 and peripheral WHUD 120 over any known wireless communication protocol, including without limitation: Bluetooth®, ZigBee®, Near-Field Communications (NFC), Wi-Fi®, and the like. However, wireless display data signals 150 may advantageously be transmitted between band 110 and peripheral WHUD 120 using a wireless communication scheme that has a low power consumption (in order to conserve battery power and enable compact, non-bulky batteries 116 and 122 to be used) but is nevertheless capable of rapidly transmitting a large quantity of data (in order to display high quality content/imagery to the user). In accordance with the present systems, devices, and methods, wireless communications between band 110 and peripheral WHUD 120 may advantageously employ an ultra-wideband wireless communication scheme. Using an ultra-wideband wireless communication scheme, wireless display data signals 150 may be embodied in low-energy radio signals distributed over a relatively large bandwidth. A person of skill in the art will be familiar with ultra-wideband wireless communication schemes and will appreciate that such schemes are particularly well-suited for short-range applications. Wireless communications between band 110 (e.g., worn on an arm of the user) and peripheral WHUD 120 (worn on the head of the user) will typically span a short range of about one meter or less, or up to about two meters if band 110 is worn, for example, on an ankle of the user. In order to implement ultra-wideband wireless communication, wireless transmitter 113 of band 110 may include an ultra-wideband wireless transmitter (e.g., a first distributed multiple-input and multiple-output, or “MIMO” antenna system) and wireless receiver 121 of peripheral WHUD 120 may include an ultra-wideband wireless receiver (e.g., a second distributed MIMO antenna system).

Throughout this specification and the appended claims, the term “ultra-wideband” is generally used to refer to wireless signals that are distributed over a relatively wide frequency range. In other words, ultra-wideband signals have a relatively high-bandwidth. In the art, the term “ultra-wideband” typically applies to a signal bandwidth that exceeds the lesser of: i) about 500 MHz; and ii) about 20% of the center frequency of the signal band. Examples of ultra-wideband communication protocols in the art that may be employed, adopted, or adapted to achieve wireless communication 150 between band 110 and peripheral WHUD 120 in accordance with the present systems, devices, and methods include, without limitation: Wireless HDMI, WirelessHD, Wireless USB, Wireless Gigabit Alliance, and Wireless Home Digital Interface.

As previously described, band 110 includes a non-transitory processor-readable storage medium or memory 112. Memory 112 is communicatively coupled to processor 111 on-board band 110 and stores processor-executable instructions that, in use, are executed by processor 111. As an example, memory 112 may store display instructions that, when executed by processor 111, cause band 110 to define and wirelessly transmit display data to peripheral WHUD 120. Peripheral WHUD 120 operates at least a first display element (e.g., 125a, 125b, or both) to display information to the user in response to wirelessly receiving display data from band 110. The display instructions may include instructions for rendering and/or generally processing graphics to be displayed on peripheral WHUD 120. For example, either as part of or in addition to the display instructions, memory 113 may include rasterization instructions that, when executed by processor 111, cause band 110 to define and wirelessly transmit rasterized display data to peripheral WHUD 120. Such rasterized display data may be readily displayed by peripheral WHUD 120 without further processing on-board peripheral WHUD 120.

Memory 113 of band 110 may also store application data and/or instructions. When accessed by processor 111, the application data and/or instructions cause band 110 to execute at least one software application, and the application may invoke the display instructions also stored in memory 113. In this way, applications and even an operating system (if applicable) that are presented to the user through peripheral WHUD 120 are stored, accessed, and executed on band 110 and off of peripheral WHUD 120. Such is distinct from other wearable heads-up displays available today, where applications are stored, accessed, and executed on-board the wearable heads-up display itself.

Wearable computer system 100 is a multi-wearable-component system that, in essence, comprises a wearable band “control center” or “computer hub” 110 that performs the major data storage and processing tasks and controls other wearable peripheral devices, such as peripheral WHUD 120. The various embodiments described herein include methods of operating such a wearable computer system.

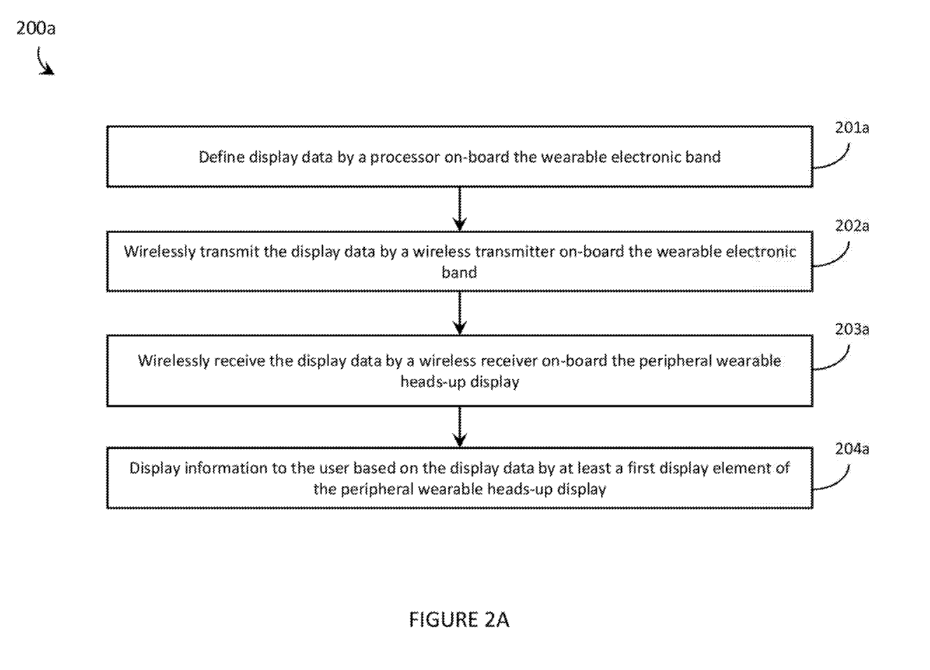

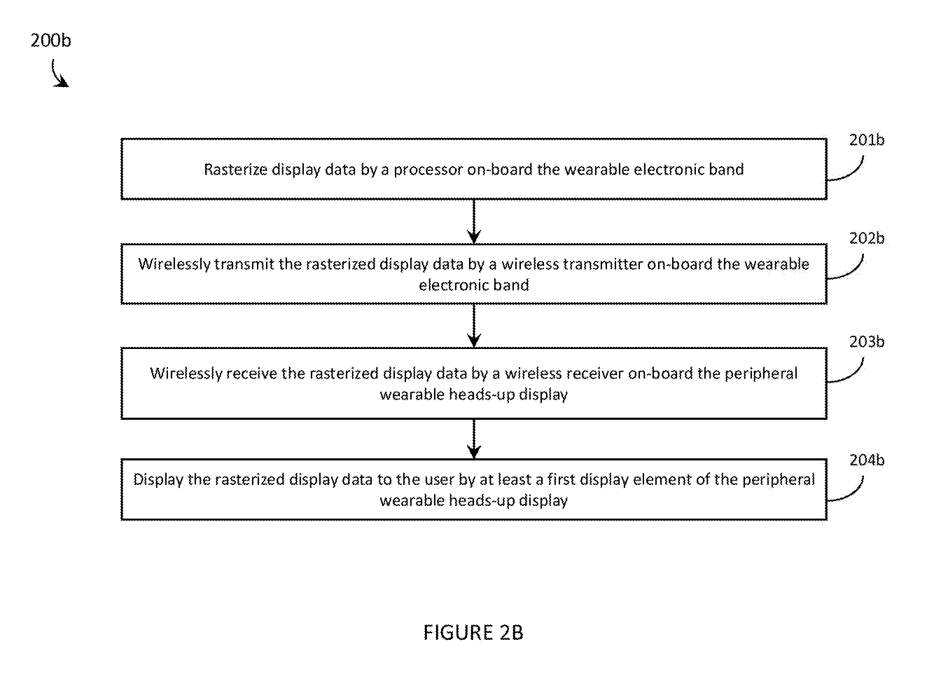

FIG. 2A is a flow-diagram showing a method 200a of operating a wearable computer system in accordance with the present systems, devices, and methods. The wearable computer system comprises a wearable electronic band worn on a limb of a user (e.g., an armband worn on an arm of the user) and a peripheral WHUD worn on a head of the user, as illustrated in the example of FIG. 1A. Method 200a includes four acts 201a, 202a, 203a, and 204a, though those of skill in the art will appreciate that in alternative embodiments certain acts may be omitted and/or additional acts may be added. Those of skill in the art will also appreciate that the illustrated order of the acts is shown for exemplary purposes only and may change in alternative embodiments. To exemplify the relationship between the acts of method 200a and the elements of exemplary wearable computer system 100 from FIGS. 1A and 1B, reference to elements of system 100 from FIGS. 1A and 1B are included in parentheses throughout the description of method 200a. However, a person of skill in the art will appreciate that method 200a may similarly be implemented using a different wearable computer system.

At 201a, a processor (111) on-board the wearable electronic band (110) defines display data. The band (110) may include a non-transitory processor-readable storage medium or memory (112) that stores processor-executable display instructions, and the processor (111) may define display data by executing the display instructions stored in the memory (112) (in other words, executing the display data instructions stored in the memory may cause the processor to define display data). In some implementations, the memory (112) of the band (110) may store at least one application that includes display instructions and the processor (111) may define display data as part of executing the application.

At 202a, a wireless transmitter (113) on-board the band (110) wirelessly transmits the display data defined by the processor (111) at act 201a. As previously described, the wireless transmitter (113) on-board the band (110) may include an ultra-wideband wireless transmitter (such as a first distributed MIMO antenna system) that wirelessly transmits the display data over an ultra-wideband frequency range having a bandwidth of, for example, 500 MHz or more.

At 203a, a wireless receiver (121) on-board the peripheral WHUD (120) wirelessly receives the display data wirelessly transmitted at act 202a. In implementations in which the display data are wirelessly transmitted over an ultra-wideband frequency range at 202a, the wireless receiver (121) on-board the peripheral WHUD (120) may include an ultra-wideband wireless receiver (such as a second distributed MIMO antenna system) that wirelessly receives the display data over the ultra-wideband frequency range.

At 204a, at least a first display element (125a and/or 125b) of the peripheral WHUD (120) displays information to the user based on the display data wirelessly received at act 203a. As previously described, the peripheral WHUD (120) may have the general shape and appearance of a set of eyeglasses and may include two separate display elements (125a and 125b, respectively), each positioned within a field of view of a respective eye of the user when the peripheral WHUD (120) is worn on the user's head. In this case, the first display element (125a) may display information to a first eye of the user based on the display data wirelessly received at act 203a and the second display element (125b) may display information to a second eye of the user based on the display data wirelessly received at act 203a.

As previously described, wearable heads-up displays available in the art today include all of the necessary on-board processing and storage hardware (e.g., processor 111 and memory 112) for them to operate as stand-alone computing devices (e.g., “smartglasses”). These components inevitably add volume to the support frames of the wearable heads-up display, causing them to be noticeably bulkier than traditional eyeglasses. The present systems, devices, and methods divide the familiar stand-alone wearable heads-up display design into a multi-wearable-component architecture in which the wearable heads-up display is a peripheral to a separate wearable “control center” (e.g., band 110). By moving structures and components off of the wearable heads-up display (e.g., “peripheral display glasses”) and onto a separate wearable device, the wearable heads-up display may be considerably reduced in bulk and made significantly more aesthetically pleasing.

In accordance with the present systems, devices, and methods, substantially all of the application storage and processing tasks performed by wearable computer system 100 are performed off of peripheral WHUD 120 and on-board band 110. When content is to be displayed to the user in response to executing an application or other instructions stored in memory 112, or in response to one or more input(s) from the user such as one or more gestural input(s) detected by one or more sensor(s) 115, 117 on-board band 110, band 110 defines display data and wirelessly transmits this display data to peripheral WHUD 120. In some implementations, peripheral WHUD 120 may include dedicated infrastructure (e.g., a specialized processor or processing circuitry) for the limited purpose of performing graphics processing of the display data and converting the display data into a form that can be displayed by one or both of display elements 125a and/or 125b. In other implementations, band 110 completes substantially all of the graphics processing and the display data that is wirelessly transmitted from band 110 to peripheral WHUD 120 is already substantially in a form that can be displayed by one or both of display elements 125a and/or 125b. This latter scenario can be advantageous because it eliminates the need for peripheral WHUD 120 to include graphics processing infrastructure. For example, band 110 (i.e., processor 111 on-board band 110) may rasterize the display data (i.e., define rasterized display data) before the display data is wirelessly transmitted to peripheral WHUD 120 by transmitter 113.

Throughout this specification and the appended claims, the term “rasterization” is used to generally refer to any process that receives input data and produces at least one raster image based on the input data. For example, a rasterization process may receive an image described in a vector graphics format (e.g., SVG), and convert that image into a raster graphics format (e.g., BMP) comprising a rectangular grid of pixels. In some implementations, rasterization of display data may include rendering the display data for display by the one or more display element(s) of the peripheral WHUD (120). Most display technologies in use today include bitmapped displays in which the display element itself comprises a rectangular grid of pixels. In accordance with the present systems, devices, and methods, first and second display elements 125a and 125b of peripheral WHUD 120 may each comprise a respective bitmapped display element (such as those described in U.S. Provisional Patent Application Ser. No. 61/928,568, now U.S. Non-Provisional patent application Ser. No. 14/599,279) that displays raster graphics data by mapping pixels from the raster graphics data to physical pixels of the display element. The information being displayed at or by each pixel of the display element(s) is typically updated on a row-by-row basis through a process known as “scanning.” Display data that is in a raster graphics format (e.g., after conversion through a rasterization process) is referred to herein as “rasterized display data.”

A person of skill in the art will appreciate that display data may grow in size as a result of rasterization. For example, the raster graphics format of an image may be larger than the vector graphics format of the same image. Thus, while performing rasterization on-board a wearable electronic band (110) as opposed to on-board a WHUD advantageously reduces (or even eliminates) the processing infrastructure required on-board the WHUD, such can also augment the requirements for the wireless communication between the band (110) and the WHUD (120). Wireless transmission of rasterized display data can be more demanding (in terms of, e.g., power consumption, bandwidth, and/or other wireless communication parameters) than wireless transmission of non-rasterized (e.g., vector) display data. As previously described, the present systems, devices, and methods may employ ultra-wideband wireless communication schemes in order to facilitate wireless transmission of rasterized display data. In some implementations, some bandwidth and/or power can be conserved by compressing the rasterized display data on-board the band (110) prior to wireless transmission and decompressing the rasterized display data on-board the peripheral WHUD (120) in accordance with known compression protocols, such as H.264. In this case, the peripheral WHUD (120) may include the limited processing infrastructure necessary to decompress the rasterized display data.

FIG. 2B is a flow-diagram showing another method 200b of operating the wearable computer system of method 200a from FIG. 2A in accordance with the present systems, devices, and methods. Method 200b is substantially similar to method 200a from FIG. 2A, except that method 200b explicitly describes rasterization of the display data on-board the wearable electronic band (e.g., band 110) as opposed to on-board the peripheral WHUD (e.g., peripheral WHUD 120). Method 200b includes four acts 201b, 202b, 203b, and 204b, which, apart from the explicit description of rasterization and rasterized display data, are substantially similar to acts 201a, 202a, 203a, and 204a, respectively, of method 200a from FIG. 2A. Those of skill in the art will appreciate that in alternative embodiments certain acts may be omitted and/or additional acts may be added. Those of skill in the art will also appreciate that the illustrated order of the acts is shown for exemplary purposes only and may change in alternative embodiments.

At 201b, the processor (111) on-board the wearable electronic band (110) rasterizes display data. Act 201b of method 200b is substantially similar to act 201a of method 200a with the refinement that “defining display data” by the processor per act 201a of method 200a explicitly involves “rasterizing the display data” in act 201b of method 200b. For the purposes of the present systems, devices, and methods, “rasterizing display data” includes “defining rasterized display data” and vice versa. The result is rasterized display data whether or not the display data was defined prior to the rasterization.

At 202b, the wireless transmitter (113) on-board the wearable electronic band (110) wirelessly transmits the rasterized display data from act 201b. Act 202b of method 200b is substantially similar to act 202b of method 200b with the refinement that “wirelessly transmitting the display data” by the wireless transmitter per act 202a of method 200a explicitly involves “wirelessly transmitting the rasterized display data” in act 202b of method 200b. Thus, in method 200b, the wireless display data signals 150 that are transmitted from band 110 are rasterized display data signals.

At 203b, the wireless receiver (121) on-board the peripheral WHUD (120) wirelessly receives the rasterized display data. Act 203b of method 200b is substantially similar to act 203a of method 200a with the refinement that “wirelessly receiving the display data” by the wireless receiver per act 203a of method 200a explicitly involves “wirelessly receiving the rasterized display data” in act 203b of method 200b.

At 204b, at least a first display element (125a and/or 125b) of the peripheral WHUD (120) displays the rasterized display data to the user. Act 204b of method 200b is substantially similar to act 204a of method 200a with the refinement that “displaying information to the user based on the display data” by at least a first display element (125a and/or 125b) per act 204a of method 200a explicitly involves “displaying the rasterized display data to the user” in act 204a of method 200a. Thus, while act 204a of method 200a allows for some limited graphics processing of the display data to be performed on-board the peripheral WHUD (120) such that the information that is displayed to the user is “based on” the display data wirelessly received at act 203a, act 204b of method 200b describes displaying the rasterized display data directly to the user substantially as received at act 203b with little to no further graphics processing of the rasterized display data performed on-board the peripheral WHUD (120) prior to it being displayed.

As previously described, the wearable electronic band (110) of the wearable computer system (100) may include a wireless transceiver (114) to provide internet connectivity for the wearable computer system (100). In such implementations, either or both of method 200a from FIG. 2A and/or method 200b from FIG. 2B may further include displaying information to the user from the internet. For example, the wireless transceiver (114) may wirelessly transmit information to the internet and wirelessly receive information from the internet, and defining (rasterized) display data per act 201a (201b) of method 200a (200b) may include defining (rasterized) display data based on information wirelessly received from the internet by the wireless transceiver (114).

As also previously described, the wearable electronic band (110) of the wearable computer system (100) may include at least one sensor (115 and/or 117) responsive to (i.e., to detect, sense, measure, or transduce) at least one input from the user. In such implementations, either or both of method 200a from FIG. 2A and/or method 200b from FIG. 2B may further include displaying information to the user based on one or more inputs detected from the user. For example, the sensor (115 and/or 117) may include a muscle activity sensor, such as an EMG sensor, and may detect one or more physical gesture(s) performed by the user. In this case, defining (rasterized) display data per act 201a (201b) of method 200a (200b) may include defining (rasterized) display data based on the one or more gesture(s) detected from the user.

The peripheral wearable heads-up displays described herein (e.g., peripheral WHUD 120) may include one or more sensor(s) (e.g., microphone, camera, thermometer, compass, and/or others) for collecting data from the user's environment. In such cases, the peripheral WHUD may include a wireless transmitter (e.g., the wireless receiver of the peripheral WHUD may be part of a wireless transceiver) that, in use, transmits data collected by the one or more sensor(s) on-board the peripheral WHUD to the wearable electronic armband. To this end, the wearable electronic band may include a wireless receiver (e.g., the wireless transmitter of the wearable electronic band may be part of a wireless transceiver) that, in use, receives data from the peripheral WHUD. Such data may then be processed on-board the wearable electronic band where any display data to be conveyed to the user based on the data collected by the peripheral WHUD may be defined and then transmitted back to the peripheral WHUD for presentation to the user.

The peripheral WHUDs described herein may display content in response to commands from the user in one or more of a variety of ways, including without limitation: voice commands through a microphone; touch commands through buttons, switches, or a touch sensitive surface; and/or gesture-based commands through gesture detection systems as described in, for example, U.S. Non-Provisional patent application Ser. No. 14/155,087 and U.S. Non-Provisional patent application Ser. No. 14/155,107. However, in accordance with the present systems, devices, and methods, such commands are processed off of the peripheral WHUD (e.g., by a processor on-board a wearable electronic band) and any resulting display data is wirelessly transmitted back to the peripheral WHUD for presentation to the user.

Throughout this specification and the appended claims the term “communicative” as in “communicative pathway,” “communicative coupling,” and in variants such as “communicatively coupled,” is generally used to refer to any engineered arrangement for transferring and/or exchanging information. Exemplary communicative pathways include, but are not limited to, electrically conductive pathways (e.g., electrically conductive wires, electrically conductive traces), magnetic pathways (e.g., magnetic media), one or more communicative link(s) through one or more wireless communication protocol(s), and/or optical pathways (e.g., optical fiber), and exemplary communicative couplings include, but are not limited to, electrical couplings, magnetic couplings, wireless couplings, and/or optical couplings.

Throughout this specification and the appended claims, infinitive verb forms are often used. Examples include, without limitation: “to detect,” “to provide,” “to transmit,” “to communicate,” “to process,” “to route,” and the like. Unless the specific context requires otherwise, such infinitive verb forms are used in an open, inclusive sense, that is as “to, at least, detect,” to, at least, provide,” “to, at least, transmit,” and so on.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other portable and/or wearable electronic devices, not necessarily the exemplary wearable electronic devices generally described above.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs executed by one or more computers (e.g., as one or more programs running on one or more computer systems), as one or more programs executed by on one or more controllers (e.g., microcontrollers) as one or more programs executed by one or more processors (e.g., microprocessors, central processing units, graphical processing units), as firmware, or as virtually any combination thereof, and that designing the circuitry and/or writing the code for the software and or firmware would be well within the skill of one of ordinary skill in the art in light of the teachings of this disclosure.

When logic is implemented as software and stored in memory, logic or information can be stored on any processor-readable medium for use by or in connection with any processor-related system or method. In the context of this disclosure, a memory is a processor-readable medium that is an electronic, magnetic, optical, or other physical device or means that contains or stores a computer and/or processor program. Logic and/or the information can be embodied in any processor-readable medium for use by or in connection with an instruction execution system, apparatus, or device, such as a computer-based system, processor-containing system, or other system that can fetch the instructions from the instruction execution system, apparatus, or device and execute the instructions associated with logic and/or information.

In the context of this specification, a “non-transitory processor-readable medium” can be any element that can store the program associated with logic and/or information for use by or in connection with the instruction execution system, apparatus, and/or device. The processor-readable medium can be, for example, but is not limited to, an electronic, magnetic, optical, electromagnetic, infrared, or semiconductor system, apparatus or device. More specific examples (a non-exhaustive list) of the computer readable medium would include the following: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), digital tape, and other non-transitory media.

The various embodiments described above can be combined to provide further embodiments. To the extent that they are not inconsistent with the specific teachings and definitions herein, all of the U.S. patents, U.S. patent application publications, U.S. patent applications, foreign patents, foreign patent applications and non-patent publications referred to in this specification and/or listed in the Application Data Sheet, including but not limited to U.S. Provisional Patent Application Ser. No. 61/989,848; U.S. Non-Provisional patent application Ser. No. 14/155,087; U.S. Non-Provisional patent application Ser. No. 14/155,107; U.S. Non-Provisional patent application Ser. No. 14/186,878; U.S. Non-Provisional patent application Ser. No. 14/186,889; U.S. Provisional Patent Application Ser. No. 61/822,740 (now U.S. Non-Provisional patent application Ser. No. 14/276,575); U.S. Provisional Patent Application Ser. No. 61/869,526 (now U.S. Non-Provisional patent application Ser. No. 14/465,194); U.S. Provisional Patent Application Ser. No. 61/874,846 (now U.S. Non-Provisional patent application Ser. No. 14/476,093); and U.S. Provisional Patent Application Ser. No. 61/928,568 (now U.S. Non-Provisional patent application Ser. No. 14/599,279), are incorporated herein by reference, in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A wearable computer system comprising:
a peripheral wearable heads-up display (“WHUD”) that, in use, is worn on a head of a user, wherein the peripheral WHUD includes at least a first display element positioned within a field of view of at least a first eye of the user when the peripheral WHUD is worn on the head of the user, and a wireless receiver communicatively coupled to the at least a first display element;
a first wearable electronic band that, in use, is worn on a limb of the user, wherein the first wearable electronic band includes a wireless transmitter and at least one sensor, the at least one sensor responsive to at least one input effected by the user, and in response to the at least one input effected by the user, the wireless transmitter of the first wearable electronic band transmits at least one control signal;
a second wearable electronic band that, in use, is worn on a limb of the user, wherein the second wearable electronic band includes at least one first processor, a first non-transitory processor-readable storage medium communicatively coupled to the at least one first processor, a wireless receiver communicatively coupled to the at least one first processor, and a wireless transmitter communicatively coupled to the at least one first processor, and wherein the first non-transitory processor-readable storage medium stores first processor-executable instructions that, when executed by the at least one first processor:
cause the wireless receiver of the second wearable electronic band to receive the at least one control signal transmitted by the wireless transmitter of the first wearable electronic band and provide the at least one control signal to the at least one first processor;
cause the at least one first processor to process the at least one control signal and to process graphics to be displayed on the peripheral WHUD based on at least the at least one control signal; and
cause the wireless transmitter of the second wearable electronic band to wirelessly transmit the processed graphics,
wherein the wireless receiver of the peripheral WHUD receives the processed graphics transmitted by the wireless transmitter of the second wearable electronic band and operates the at least a first display element based on the processed graphics.

2. The wearable computer system of claim 1 wherein the at least one sensor of the first wearable electronic band includes at least one muscle activity sensor responsive to muscle activity of the user when the user performs a physical gesture.

3. The wearable computer system of claim 1 wherein the at least one sensor of the first wearable electronic band is selected from the group consisting of: an electromyography sensor, a mechanomyography sensor, an accelerometer, a gyroscope, an electrocardiography sensor, a blood pressure sensor, a global positioning system sensor, and a compass.

4. The wearable computer system of claim 1 wherein the first processor-executable instructions that, when executed by the at least one first processor, cause the at least one first processor to process the at least one control signal and process graphics to be displayed on the peripheral WHUD based on at least the at least one control signal cause the at least one first processor to process the graphics as rasterized graphics to be displayed on the peripheral WHUD.

5. The wearable computer system of claim 4 wherein:
the first processor-executable instructions, when executed by the at least one first processor, further cause the at least one first processor to compress the rasterized graphics as compressed rasterized graphics; and
the peripheral WHUD further includes at least one second processor and a second non-transitory processor-readable storage medium, wherein the at least one second processor is communicatively coupled to the at least a first display element, the wireless receiver of the peripheral WHUD, and the second non-transitory processor-readable storage medium, the second non-transitory processor-readable storage medium having processor-executable instructions stored thereon that, when executed by the at least one second processor, in response to wirelessly receiving the compressed rasterized graphics from the wearable electronic band by the wireless receiver of the peripheral WHUD, cause the at least one second processor to decompress the compressed rasterized graphics and operate the at least a first display element to display the decompressed rasterized graphics to the user.

6. The wearable computer system of claim 1 wherein the first non-transitory processor-readable storage medium of the second wearable electronic band further stores at least one of processor-executable application instructions, application data, processor-executable operating system instructions, and operating system data that, when accessed by the at least one first processor, cause the at least one first processor of the second wearable electronic band to execute at least one application or operating system that invokes the processor-executable instructions that cause the wireless receiver of the second wearable electronic band to receive the at least one control signal transmitted by the wireless transmitter of the first wearable electronic band and provide the at least one control signal to the at least one first processor; cause the at least one first processor to process the at least one control signal and to process graphics to be displayed on the peripheral WHUD based on at least the at least one control signal; and cause the wireless transmitter of the second wearable electronic band to wirelessly transmit the processed graphics.

7. The wearable computer system of claim 1 wherein the wireless transmitter of the second wearable electronic band includes an ultra-wideband wireless transmitter to wirelessly transmit the processed graphics over an ultra-wideband frequency range that exceeds a lesser of 500 MHz and 20% of a center frequency thereof, and the peripheral WHUD includes an ultra-wideband wireless receiver to receive the processed graphics over the ultra-wideband frequency range.

8. The wearable computer system of claim 7 wherein the ultra-wideband wireless transmitter of the second wearable electronic band includes a first distributed multiple-input and multiple-output antenna system and the ultra-wideband wireless receiver of the peripheral WHUD includes a second multiple-input and multiple-output antenna system.

9. The wearable computer system of claim 7 wherein the second wearable electronic band includes a wireless transceiver communicatively coupled to the at least a first processor, the wireless transceiver including the ultra-wideband wireless transmitter, and wherein in use the wireless transceiver provides wireless internet connectivity for the wearable computer system.

10. The wearable computer system of claim 1 wherein the second wearable electronic band includes a wireless transceiver communicatively coupled to the at least one first processor, the wireless transceiver including the wireless transmitter of the second wearable electronic band, and the first processor-executable instructions, when executed by the at least one first processor, further cause the at least one first processor to:
wirelessly transmit information to the internet by the wireless transceiver;
wirelessly receive information from the internet by the wireless transceiver; and
process graphics based on the information wirelessly received from the internet.

11. The wearable computer system of claim 1 wherein the at least a first display element of the peripheral WHUD includes both a first display element and a second display element, and wherein when the peripheral WHUD is worn on the head of the user the first display element is positioned in the field of view of the first eye of the user and the second display element is positioned in a field of view of a second eye of the user.

12. The wearable computer system of claim 1 wherein the peripheral WHUD has a shape and appearance of a set of eyeglasses.
